(19) United States
(12) Patent Application Publication
(10) Pub. No.: US 2025/0341967 A1
(43) Pub. Date: Nov. 6, 2025

(54) METHODS FOR DATA PRIORITIZATION IN MEMORY

(71) Applicant: Micron Technology, Inc., Boise, ID (US)

(72) Inventors: William N. Thanos, Scotts Valley, CA (US); Kyle J. Wilkins, Meridian, ID (US); Prasad V. Alluri, El Dorado Hills, CA (US); Roy Leonard, San Jose, ID (US); Cory M. Steinmetz, Boise, ID (US)

(21) Appl. No.: 19/183,684

(22) Filed: Apr. 18, 2025

Related U.S. Application Data
(60) Provisional application No. 63/643,263, filed on May 6, 2024.

(51) Int. Cl. G06F 3/06

(52) U.S. Cl. CPC G06F 3/0611; G06F 3/0659; G06F 3/0673

(57) ABSTRACT

Methods, systems, and devices for methods for data prioritization in memory are described. A memory device may be configured to prioritize data such that high-priority data may remain in a cache to await operations while low-priority data may be transferred to higher-latency memory. For example, the memory device may receive a command to write data associated with one or more user operations to the memory system. The memory device may also receive an indication associated with the data that indicates to the memory device that the data is high priority. The memory device may store the data in a cache of the memory device to await operations. In response to a trigger, the memory device may transfer data not associated with the indication from the cache to multi-level memory cells (MLCs) of the memory device, such that the high-priority files may remain in the cache.

### CROSS REFERENCE

The present Application for Patent claims priority to U.S. Patent Application No. 63/643,263 by Thanos et al., entitled “METHODS FOR DATA PRIORITIZATION IN MEMORY,” filed May 6, 2024, which is assigned to the assignee hereof, and which is expressly incorporated by reference in its entirety herein.

### TECHNICAL FIELD

The following relates to one or more systems for memory, including methods for data prioritization in memory.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 shows an example of a system that supports methods for data prioritization in memory in accordance with examples as disclosed herein.

FIG. 2 shows an example of a memory architecture that supports methods for data prioritization in memory in accordance with examples as disclosed herein.

FIG. 3 shows a block diagram of a memory system that supports methods for data prioritization in memory in accordance with examples as disclosed herein.

FIG. 4 shows a flowchart illustrating a method or methods that support methods for data prioritization in memory in accordance with examples as disclosed herein.

### DETAILED DESCRIPTION

A memory system, including one or more memory devices may support artificial intelligence (AI) operations, machine learning (ML) operations, or other system-level operations (e.g., or a combination thereof). These operations may utilize extensive memory resources (e.g., volatile memory). In some cases, these applications may compete for memory resources of the memory system. To manage data and reduce latency, the memory system may utilize memory caches. In some cases, the memory system may utilize a cache to temporarily store data associated with pending operations (e.g., actions, tasks). In the case that the cache reaches a threshold or other condition, the memory system may process (e.g., delete, transfer) old data from the cache to allocate space for new data. However, while removing old data from the cache, the memory system may remove data that may be associated with high-priority (e.g., low latency) operations. This may cause the applications to have to recompete for the memory resources of the memory system, which may cause added system latency.

To reduce latency in applications and related operations, a memory device may be configured to prioritize data such that high-priority data (e.g., latency-sensitive data, data associated with a low latency quality of service (QOS)) may remain in a cache to await operations while low-priority data (e.g., latency-tolerant data, data associated with a higher latency QoS) may be transferred to higher-latency memory. For example, the memory device may receive a command to write data associated with an operation. The memory device may also receive an indication associated with the data that indicates to the memory device that the data is high priority. The memory device may store the tag and the data in a cache of the memory device to await operations. In response to a trigger indicating that data has to be relocated from the cache, the memory device may transfer data not associated with the indication (e.g., low priority files) from the cache to multi-level memory cells (MLCs) (e.g., triple-level memory cells (TLCs), quadruple-level memory cells (QLCs)) of the memory device, such that the high-priority files may remain in the cache.

In addition to applicability in memory systems as described herein, techniques for data prioritization in memory may be generally implemented to improve the performance of various electronic devices and systems (including AI applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

Features of the disclosure are illustrated and described in the context of systems, devices, and circuits. Features of the disclosure are further illustrated and described in the context of memory architectures and flowcharts.

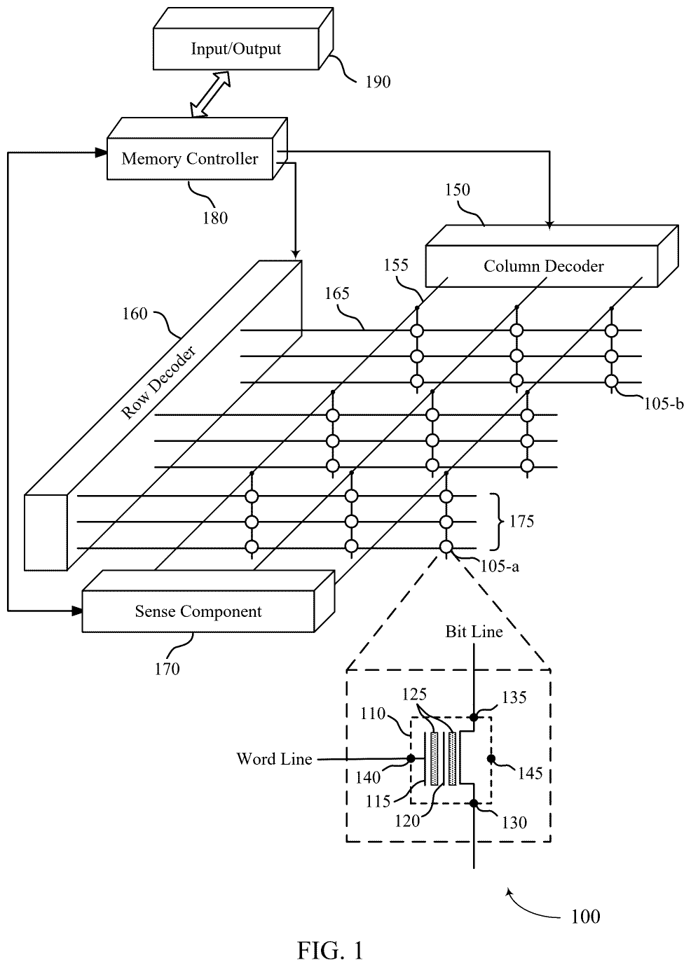

FIG. 1 shows an example of a memory device 100 that supports methods for data prioritization in memory in accordance with examples as disclosed herein. FIG. 1 is an illustrative representation of various components and features of the memory device 100. As such, the components and features of the memory device 100 are shown to illustrate functional interrelationships, and not necessarily physical positions within the memory device 100. Further, although some elements included in FIG. 1 are labeled with a numeric indicator, some other corresponding elements are not labeled, even though they are the same or would be understood to be similar, in an effort to increase visibility and clarity of the depicted features.

The memory device 100 may include one or more memory cells 105, such as memory cell 105-a and memory cell 105-b. In some examples, a memory cell 105 may be a NAND memory cell, such as in the blow-up diagram of memory cell 105-a. Each memory cell 105 may be programmed to store a logic value representing one or more bits of information. In some examples, a single memory cell 105—such as a memory cell 105 configured as a single-level cell (SLC)—may be programmed to one of two supported states and thus may store one bit of information at a time (e.g., a logic 0 or a logic 1). In some other examples, a single memory cell 105—such a memory cell 105 configured as a multi-level cell (MLC), a tri-level cell (TLC), a quad-level cell (QLC), or other type of multiple-level memory cell 105—may be programmed to one state of more than two supported states and thus may store more than one bit of information at a time. In some cases, a multiple-level memory cell 105 (e.g., an MLC memory cell, a TLC memory cell, a QLC memory cell) may be physically different than an SLC cell. For example, a multiple-level memory cell 105 may use a different cell geometry or may be fabricated using different materials. In some examples, a multiple-level memory cell 105 may be physically the same or similar to an SLC cell, and other circuitry in a memory block (e.g., a controller, sense amplifiers, drivers) may be configured to operate (e.g., read and program) the memory cell as an SLC cell, or as an MLC cell, or as a TLC cell, etc.

In some NAND memory arrays, each memory cell 105 may be illustrated as a transistor that includes a charge trapping structure (e.g., a floating gate, a replacement gate, a dielectric material) for storing an amount of charge representative of a logic value. For example, the blow-up in FIG. 1 illustrates a NAND memory cell 105-a that includes a transistor 110 (e.g., a metal-oxide-semiconductor (MOS) transistor) that may be used to store a logic value. The transistor 110 may include a control gate 115 and a charge trapping structure 120 (e.g., a floating gate, a replacement gate), where the charge trapping structure 120 may, in some examples, be between two portions of dielectric material 125. The transistor 110 also may include a first node 130 (e.g., a source or drain) and a second node 135 (e.g., a drain or source). A logic value may be stored in transistor 110 by storing (e.g., writing) a quantity of electrons (e.g., an amount of charge) on the charge trapping structure 120. An amount of charge to be stored on the charge trapping structure 120 may depend on the logic value to be stored. The charge stored on the charge trapping structure 120 may affect the threshold voltage of the transistor 110, thereby affecting the amount of current that flows through the transistor 110 when the transistor 110 is activated (e.g., when a voltage is applied to the control gate 115, when the memory cell 105-a is read). In some examples, the charge trapping structure 120 may be an example of a floating gate or a replacement gate that may be part of a 2D NAND structure. For example, a 2D NAND array may include multiple control gates 115 and charge trapping structures 120 arranged around a single channel (e.g., a horizontal channel, a vertical channel, a columnar channel, a pillar channel).

A logic value stored in the transistor 110 may be sensed (e.g., as part of a read operation) by applying a voltage to the control gate 115 (e.g., to control node 140, via a word line 165) to activate the transistor 110 and measuring (e.g., detecting, sensing) an amount of current that flows through the first node 130 or the second node 135 (e.g., via a bit line 155). For example, a sense component 170 may determine whether an SLC memory cell 105 stores a logic 0 or a logic 1 in a binary manner (e.g., based on a presence or absence of a current through the memory cell 105 when a read voltage is applied to the control gate 115, based on whether the current is above or below a threshold current). For a multiple-level memory cell 105, a sense component 170 may determine a logic value stored in the memory cell 105 based on various intermediate threshold levels of current when a read voltage is applied to the control gate 115, or by applying different read voltages to the control gate and evaluating different resulting levels of current through the transistor 110, or various combinations thereof. In one example of a multiple-level architecture, a sense component 170 may determine the logic value of a TLC memory cell 105 based on eight different levels of current, or ranges of current, that define the eight potential logic values that could be stored by the TLC memory cell 105.

An SLC memory cell 105 may be written by applying one of two voltages (e.g., a voltage above a threshold or a voltage below a threshold) to the memory cell 105 to store, or not store, an electric charge on the charge trapping structure 120 and thereby cause the memory cell 105 to store one of two possible logic values. For example, when a first voltage is applied to the control node 140 (e.g., via a word line 165) relative to a bulk node 145 (e.g., a body node) for the transistor 110 (e.g., when the control node 140 is at a higher voltage than the bulk), electrons may tunnel into the charge trapping structure 120. Injection of electrons into the charge trapping structure 120 may be referred to as programming the memory cell 105 and may occur as part of a write operation. A programmed memory cell may, in some cases, be considered as storing a logic 0. When a second voltage is applied to the control node 140 (e.g., via the word line 165) relative to the bulk node 145 for the transistor 110 (e.g., when the control node 140 is at a lower voltage than the bulk node 145), electrons may leave the charge trapping structure 120. Removal of electrons from the charge trapping structure 120 may be referred to as erasing the memory cell 105 and may occur as part of an erase operation. An erased memory cell may, in some cases, be considered as storing a logic 1. In some cases, memory cells 105 may be programmed at a page level of granularity due to memory cells 105 of a page sharing a common word line 165, and memory cells 105 may be erased at a block level of granularity due to memory cells 105 of a block sharing commonly biased bulk nodes 145.

In contrast to writing an SLC memory cell 105, writing a multiple-level (e.g., MLC, TLC, or QLC) memory cell 105 may involve applying different voltages to the memory cell 105 (e.g., to the control node 140 or bulk node 145 thereof) at a finer level of granularity to more finely control the amount of charge stored on the charge trapping structure 120, thereby enabling a larger set of logic values to be represented. Thus, multiple-level memory cells 105 may provide greater density of storage relative to SLC memory cells 105 but may, in some cases, involve narrower read or write margins or greater complexities for supporting circuitry.

A charge-trapping NAND memory cell 105 may operate similarly to a floating-gate NAND memory cell 105 but, instead of or in addition to storing a charge on a charge trapping structure 120, a charge-trapping NAND memory cell 105 may store a charge representing a logic state in a dielectric material between the control gate 115 and a channel (e.g., a channel between a first node 130 and a second node 135). Thus, a charge-trapping NAND memory cell 105 may include a charge trapping structure 120, or may implement charge trapping functionality in one or more portions of dielectric material 125, among other configurations.

In some examples, each page of memory cells 105 may be connected to a corresponding word line 165, and each column of memory cells 105 may be connected to a corresponding bit line 155 (e.g., digit line). Thus, one memory cell 105 may be located at the intersection of a word line 165 and a bit line 155. This intersection may be referred to as an address of a memory cell 105. In some cases, word lines 165 and bit lines 155 may be substantially perpendicular to one another, and may be generically referred to as access lines or select lines.

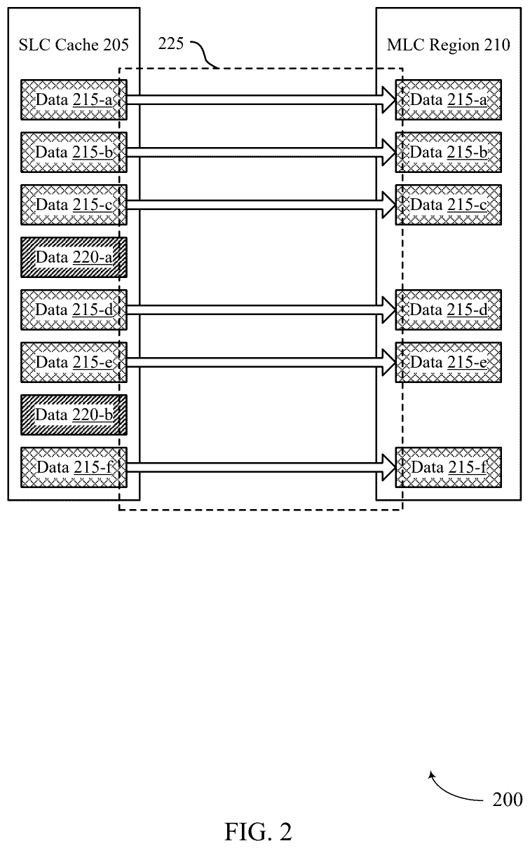

In some cases, a memory device 100 may include a three-dimensional (3D) memory array, where multiple two-dimensional (2D) memory arrays may be formed on top of one another. In some examples, such an arrangement may increase the quantity of memory cells 105 that may be fabricated on a single die or substrate as compared with 1D arrays, which, in turn, may reduce production costs, or increase the performance of the memory array, or both. In the example of FIG. 1, memory device 100 includes multiple levels (e.g., decks, layers, planes, tiers) of memory cells 105. The levels may, in some examples, be separated by an electrically insulating material. Each level may be aligned or positioned so that memory cells 105 may be aligned (e.g., exactly aligned, overlapping, or approximately aligned) with one another across each level, forming a memory cell stack 175. In some cases, memory cells aligned along a memory cell stack 175 may be referred to as a string of memory cells 105 (e.g., as described with reference to FIG. 2).

Accessing memory cells 105 may be controlled through a row decoder 160 and a column decoder 150. For example, the row decoder 160 may receive a row address from the memory controller 180 and activate an appropriate word line 165 based on the received row address. Similarly, the column decoder 150 may receive a column address from the memory controller 180 and activate an appropriate bit line 155. Thus, by activating one word line 165 and one bit line 155, one memory cell 105 may be accessed. As part of such accessing, a memory cell 105 may be read (e.g., sensed) by sense component 170. For example, the sense component 170 may be configured to determine the stored logic value of a memory cell 105 based on a signal generated by accessing the memory cell 105. The signal may include a current, a voltage, or both a current and a voltage on the bit line 155 for the memory cell 105 and may depend on the logic value stored by the memory cell 105. The sense component 170 may include various circuitry (e.g., transistors, amplifiers) configured to detect and amplify a signal (e.g., a current or voltage) on a bit line 155. The logic value of memory cell 105 as detected by the sense component 170 may be output via input/output component 190. In some cases, a sense component 170 may be a part of a column decoder 150 or a row decoder 160, or a sense component 170 may otherwise be connected to or in electronic communication with a column decoder 150 or a row decoder 160.

A memory cell 105 may be programmed or written by activating the relevant word line 165 and bit line 155 to enable a logic value (e.g., representing one or more bits of information) to be stored in the memory cell 105. A column decoder 150 or a row decoder 160 may accept data (e.g., from the input/output component 190) to be written to the memory cells 105. In the case of NAND memory, a memory cell 105 may be written by storing electrons in a charge trapping structure or an insulating layer.

A memory controller 180 may control the operation (e.g., read, write, re-write, refresh) of memory cells 105 through the various components (e.g., row decoder 160, column decoder 150, sense component 170). In some cases, one or more of a row decoder 160, a column decoder 150, and a sense component 170 may be co-located with a memory controller 180. A memory controller 180 may generate row and column address signals in order to activate a desired word line 165 and bit line 155. In some examples, a memory controller 180 may generate and control various voltages or currents used during the operation of memory device 100.

Data associated with AI operations, machine learning (ML) operations, or other system-level operations (e.g., or a combination thereof) may utilize a large quantity of volatile memory (e.g., RAM, DRAM) in the memory device 100. In the case that multiple user applications may be performing operations (e.g., AI/ML operations, system operations), the applications may compete for system RAM to utilize in the operations. To manage data and reduce latency between various application operations performed by the users, the memory device 100 may utilize memory caches. For example, traditionally, the memory device 100 may utilize a cache to temporarily store data associated with pending operations. In the case that the cache may reach a fill threshold (e.g., or in response to another trigger), the memory device 100 may remove older data from the cache to make room for data associated with incoming commands. However, while removing older data from the cache, the memory device 100 may remove data associated with a high priority, AI/ML operations from the cache. This may cause the multiple user applications to once again compete for RAM of the memory device 100, which may cause system latency. Thus, a way to better manage cache data in the memory device 100 may be beneficial.

To reduce latency in user application operations, the memory device 100 may be configured to prioritize data such that high-priority (e.g., latency-sensitive) data may remain in a cache to await operations while low-priority data may be transferred to higher-latency memory. For example, the memory device 100 may receive a command to write data associated with an operation to the memory device 100. The memory device 100 may also receive an indication (e.g., a hint) associated with the data that indicates to the memory device 100 that the data is high priority. The memory device 100 may store the data in a cache of the memory device 100 to await operations. In response to a trigger indicating to move data from the cache, the memory device 100 may transfer data not associated with the indication (e.g., low priority files) from the cache to the MLC memory cells 105 (e.g., the TLC memory cells 105, the QLC memory cells 105) of the memory device 100, such that the high-priority files may remain in the cache. In some examples, a degree of priority as described herein may refer to a degree of latency sensitivity, with a higher priority corresponding to a higher degree of latency sensitivity and hence a smaller associated access latency (e.g., a smaller maximum allowable access latency), and a lower priority corresponding to a lower degree of latency sensitivity and hence a higher associated access latency (e.g., a larger maximum allowable access latency, or no specified maximum allowable access latency).

FIG. 2 shows an example of a memory architecture 200 that supports methods for data prioritization in memory in accordance with examples as disclosed herein. The memory architecture 200 may be an example of (e.g., or include) a portion of a memory device, such as a memory device 100. For example, the memory architecture 200 may include an SLC cache 205 that may include one or more SLC memory cells, which may be examples of SLC memory cells 105 as described with reference to FIG. 1. The memory architecture 200 may also include an MLC region 210 that may include one or more MLC memory cells (e.g., TLC memory cells, QLC memory cells), which may be examples of MLC memory cells 105, TLC memory cells 105, QLC memory cells 105, or a combination thereof as described with reference to FIG. 1.

The memory architecture 200 may include the SLC cache 205 and the MLC region 210. The SLC cache 205 may include one or more SLC memory cells that may temporarily store data prior to the memory device transferring the data to MLC memory cells of the MLC region 210 during a transfer operation 225, to volatile memory (e.g., RAM, DRAM) for use in various user operations, or a combination thereof. The SLC cache 205 and the MLC region 210 may store varying types of data. For example, each of the SLC cache 205 and the MLC region 210 may store low-priority data 215 (e.g., low-priority data 215-a, low-priority data 215-b, low-priority data 215-c, low-priority data 215-d, low-priority data 215-e, low-priority data 215-f), high-priority data 220 (e.g., high-priority data 220-a high-priority data 220-b), or a combination thereof. In some examples, the high-priority data 220 may include data with a higher sensitivity to latency, relative to the low-priority data 215. For example, the high-priority data 220 may be an example of AI operation data, ML operation data, or other latency-sensitive user operation data. The SLC memory cells of the SLC cache 205 may be associated with fast access speeds, relative to access speeds of the MLC memory cells of the MLC region 210. Additionally, or alternatively, the MLC region 210 may include a larger quantity of MLC memory cells than a quantity of SLC memory cells included in the SLC cache 205.

A memory device (e.g., associated with the memory architecture 200, including the memory architecture 200) may utilize the SLC cache 205 to manage data and reduce latency in various operations. For example, data associated with various user operations (e.g., AI operations, ML operations, other system-level operations) may utilize a large quantity of volatile memory (e.g., RAM, DRAM) in the memory device. In the case that multiple user applications may be performing operations, the applications may compete for the volatile memory to utilize in performing the operations. To manage data and reduce latency between various application operations performed by the users, the memory device may utilize the SLC cache 205. For example, the memory device may utilize the SLC cache 205 to temporarily store data (e.g., the low-priority data 215, the high-priority data 220) associated with pending operations. Traditionally, in the case that the SLC cache 205 may reach a fill threshold (e.g., or in response to another trigger), the memory device would remove older data from the SLC cache 205 to make room for data associated with incoming commands. However, while removing older data from the SLC cache 205, the memory device may remove data associated with high-priority operations (e.g., AI/ML operations, other user operations) from the SLC cache 205. This may cause the multiple user applications to once again compete for the volatile memory of the memory device, which may cause system latency.

To reduce latency in user application operations, the memory device may be configured to prioritize data such that the high-priority data 220 may remain in the SLC cache 205 to await operations while the low-priority data 215 may be transferred to the MLC region 210 (e.g., higher latency memory). For example, the memory device may receive a command to write data associated with an operation to the memory device. The memory device may also receive an indication (e.g., a hint) associated with the data that indicates to the memory device that the data includes the high-priority data 220. The memory device may store the high-priority data 220 in the SLC cache 205 of the memory device to await operations. In response to a trigger indicating to move data from the SLC cache 205, the memory device may transfer data not associated with the indication (e.g., the low-priority data 215) from the SLC cache 205 to the MLC region 210 (e.g., to the MLC memory cells, the TLC memory cells, the QLC memory cells) of the memory device, such that the high-priority data 220 may remain in the SLC cache 205.

The memory device may receive the high-priority data 220 and write it to the SLC cache 205. For example, the memory device may receive a command to write a first set of data to the memory device for use in user application operations. The memory device may also receive an indication of a tag (e.g., a hint) associated with the first set of data that indicates to the memory device that the first set of data may be high-priority data (e.g., the high-priority data 220). The tag may include a set value in one or more logical block addresses associated with the high-priority data 220. In some examples, the tag may be based on the high-priority data 220 being associated with an artificial intelligence model, a machine learning model, a virtual random access space, a high prioritization level (e.g., a low latency level), or a combination thereof. A virtual random access space may refer to a portion of non-volatile storage (e.g., NAND storage) that is configured to provide, for a host system, storage (e.g., overflow storage) for information that would otherwise be stored in RAM (e.g., DRAM) associated with the host system and in a manner that mimics RAM behavior (e.g., by providing a low access latency, at least relative to one or more other storage areas within the non-volatile storage). A virtual random access space may be referred to, for example, as a random access extension space, a swap space, a swap file, a page file, or a paging file for the host system.

In response to receiving the write command, the memory device may write the high-priority data 220 to the SLC cache 205 utilizing an SLC memory cell programming operation. In some examples, the memory device may also write information to the SLC cache 205 that indicates that the high-priority data 220 is associated with the tag.

The memory device may also receive the low-priority data 215 and write it to the SLC cache 205. For example, the memory device may receive a second command to write a second set of data to the memory device. In some examples, the memory device may not receive an indication of a tag indicating the second data to be high priority, thus the memory device may determine the second data to be low-priority data (e.g., the low-priority data 215). In some examples, the command to write the low-priority data 215 to the memory device may be received after receiving the command to write the high-priority data 220 to the memory device. In response to receiving the second write command, the memory device may write the low-priority data 215 to the SLC cache 205 utilizing the SLC memory cell programming operation. In some cases, the memory device may write the low-priority data 215 to the SLC cache 205 after writing the high-priority data 220 to the SLC cache 205.

The memory device may perform the transfer operation 225 to transfer the low-priority data 215 from the SLC cache 205 to the MLC region 210. For example, after writing the data (e.g., the high-priority data 220, the low-priority data 215) to the SLC cache 205 and in response to a trigger, the memory device may initiate the transfer operation 225. In some examples, the trigger may be an example of a quantity of data within the SLC cache 205 satisfying a threshold quantity of data, a command (e.g., from a host system for the memory system) to perform the transfer operation 225, a latency condition, a garbage collection procedure, or any combination thereof. The memory device may determine which of the data within the SLC cache 205 may be associated with the tag (e.g., the tag indicating high priority, a high sensitivity to latency). For example, the memory device may determine the high-priority data 220 to be associated with the tag, and the low-priority data 215 to not be associated with the tag. In response to determining that the low-priority data 215 is not associated with the tag (e.g., and in response to the trigger), the memory device may perform the transfer operation 225 to transfer the low-priority data 215 to the MLC region 210 utilizing an MLC memory cell programming operation. The memory device may refrain from transferring the high-priority data 220 (e.g., may maintain the high-priority data 220 in the SLC cache 205) based on the high-priority data 220 being associated with the tag, however, such that the high-priority data 220 may remain in the SLC cache 205.

In some examples, the memory device may associate the data 220 with a new tag (e.g., an updated tag, a second tag) to indicate a change in priority level (e.g., a change in access latency) for the data 220. For example, after performing the transfer operation 225 to transfer the low-priority data 215 to the MLC region 210, the memory device may associate the data 220 with a different tag (e.g., a different tag value) to indicate that the data 220 is no longer associated with a high priority level. For example, when the data 220 is high priority, the data 220 may be associated with a first tag corresponding to a first tag value (e.g., 11b), which may correspond to a low access latency, and when the data is switched to be low priority, the data 220 may be associated with a second tag corresponding to a second tag value (e.g., 00b), which may correspond to higher acceptable access latency (or an unspecified access latency, meaning no specified latency requirement). In some examples, associating the data 220 with the different tag may include setting a second value in the one or more logical block addresses associated with the data 220. After updating the tag, the memory device may perform a second transfer operation 225 to transfer the data 220 (e.g., deprioritized data) from the SLC cache 205 to the MLC region 210 utilizing the MLC memory cell programming operation. Associated the data 220 with a different (e.g., updated) tag may enable the memory device to deprioritize the data 220 without rewriting the data 220 itself into the SLC cache 205.

Utilizing a tag to prioritize data such that the high-priority data 220 may remain in the SLC cache 205 may reduce latency in user applications by decreasing a need for user operations to compete for processing space. Additionally, or alternatively, tagging the high-priority data 220 may enable an increase in read and write operation speed associated with the SLC cache 205 while also allowing the memory device to update high-priority data 220 (e.g., AI/ML files) quicker than with untagged data.

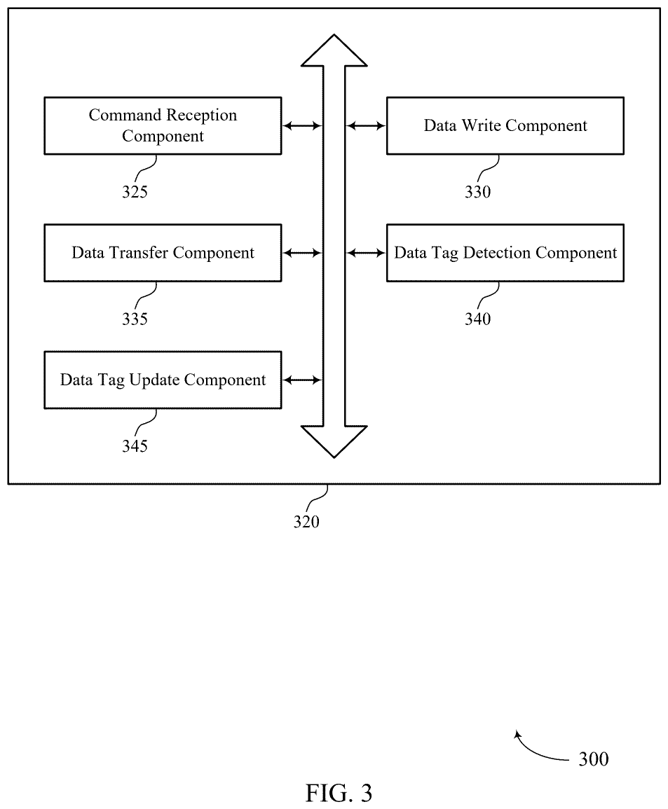

FIG. 3 shows a block diagram 300 of a memory system 320 that supports methods for data prioritization in memory in accordance with examples as disclosed herein. The memory system 320 may be an example of aspects of a memory system as described with reference to FIGS. 1 through 3. The memory system 320, or various components thereof, may be an example of means for performing various aspects of methods for data prioritization in memory as described herein. For example, the memory system 320 may include a command reception component 325, a data write component 330, a data transfer component 335, a data tag detection component 340, a data tag update component 345, or any combination thereof. Each of these components, or components of subcomponents thereof (e.g., one or more processors, one or more memories), may communicate, directly or indirectly, with one another (e.g., via one or more buses).

The command reception component 325 may be configured as or otherwise support a means for receiving a command to write a first set of data to the memory system and an indication of a tag associated with the first set of data. The data write component 330 may be configured as or otherwise support a means for writing, based at least in part on the command, the first set of data to a cache of the memory system in accordance with a first type of programming operation. The data transfer component 335 may be configured as or otherwise support a means for performing, after writing the first set of data to the cache of the memory system, a transfer operation to transfer a second set of data from the cache to a second portion of the memory system in accordance with a second type of programming operation, where the first set of data remains in the cache after the transfer operation based at least in part on the first set of data being associated with the tag.

In some examples, to support performing the transfer operation, the data transfer component 335 may be configured as or otherwise support a means for refraining from transferring, as part of the transfer operation, the first set of data from the cache to the second portion of the memory system based at least in part on the first set of data being associated with the tag, where the tag indicates a high priority level.

In some examples, to support performing the transfer operation, the data tag detection component 340 may be configured as or otherwise support a means for determining, in response to a trigger associated with the transfer operation, whether the first set of data, the second set of data, or any combination thereof is associated with the tag. In some examples, to support performing the transfer operation, the data transfer component 335 may be configured as or otherwise support a means for transferring the second set of data from the cache to the second portion of the memory system based at least in part on determining that the first set of data is associated with the tag.

In some examples, the trigger is based at least in part on a quantity of data within the cache satisfying a threshold quantity, a command to perform the transfer operation, a latency condition, a garbage collection procedure, or any combination thereof.

In some examples, the tag is based at least in part on the first set of data being associated with an artificial intelligence model, a machine learning model, or any combination thereof.

In some examples, the tag is based at least in part on the first set of data being associated with a virtual random access space for a host system associated with the memory system.

In some examples, the cache includes single-level memory cells. In some examples, the second portion of the memory system includes multiple-level memory cells.

In some examples, the command reception component 325 may be configured as or otherwise support a means for receiving, at the memory system, a second write command to write a third set of data to the memory system, the third set of data not associated with the tag. In some examples, the data write component 330 may be configured as or otherwise support a means for writing, based at least in part on the second write command, the third set of data to the cache of the memory system in accordance with the first type of programming operation. In some examples, the data transfer component 335 may be configured as or otherwise support a means for performing, after writing the third set of data to the cache of the memory system, a second transfer operation to transfer the third set of data from the cache to the second portion of the memory system in accordance with the second type of programming operation, where the first set of data remains in the cache after the second transfer operation based at least in part on the first set of data being associated with the tag.

In some examples, the command reception component 325 may be configured as or otherwise support a means for receiving, at the memory system, a second write command to write the second set of data to the memory system, where the second write command is received after the command to write the first set of data, and where the second set of data is not associated with the tag. In some examples, the data write component 330 may be configured as or otherwise support a means for writing, based at least in part on the second write command, the second set of data to the cache of the memory system in accordance with the first type of programming operation, where the first set of data is written to the cache prior to writing the second set of data to the cache, and where the second set of data is transferred to the second portion of the memory system as part of the transfer operation based at least in part on the second set of data not being associated with the tag.

In some examples, the data write component 330 may be configured as or otherwise support a means for writing, to the cache, information that indicates the first set of data is associated with the tag.

In some examples, the tag indicates a first priority of (e.g., a high priority of, a low latency QoS for) the first set of data.

In some examples, the data tag update component 345 may be configured as or otherwise support a means for associating, based at least in part on the transfer operation, the first set of data with a second tag corresponding to a second priority different than the first priority. In some examples, the data transfer component 335 may be configured as or otherwise support a means for performing, after associating the first set of data with the second tag, a second transfer operation to transfer the first set of data from the cache to the second portion of the memory system in accordance with the second type of programming operation.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

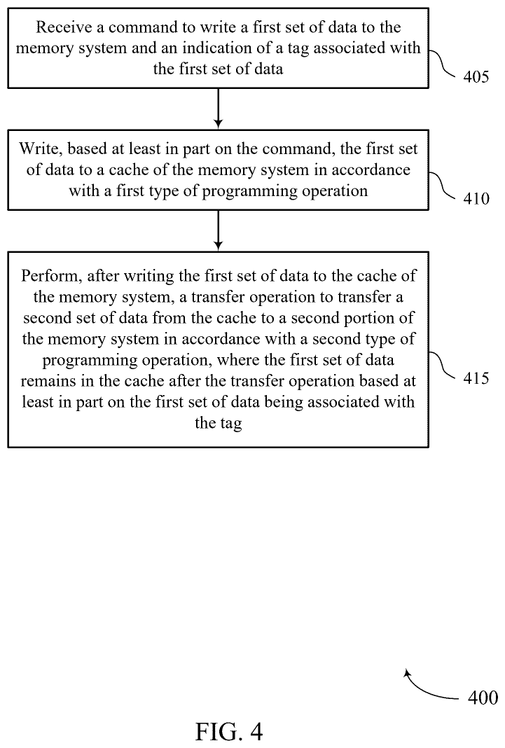

FIG. 4 shows a flowchart illustrating a method 400 that supports methods for data prioritization in memory in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include receiving a command to write a first set of data to the memory system and an indication of a tag associated with the first set of data. In some examples, aspects of the operations of 405 may be performed by a command reception component 325 as described with reference to FIG. 3.

At 410, the method may include writing, based at least in part on the command, the first set of data to a cache of the memory system in accordance with a first type of programming operation. In some examples, aspects of the operations of 410 may be performed by a data write component 330 as described with reference to FIG. 3.

At 415, the method may include performing, after writing the first set of data to the cache of the memory system, a transfer operation to transfer a second set of data from the cache to a second portion of the memory system in accordance with a second type of programming operation, where the first set of data remains in the cache after the transfer operation based at least in part on the first set of data being associated with the tag. In some examples, aspects of the operations of 415 may be performed by a data transfer component 335 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a command to write a first set of data to the memory system and an indication of a tag associated with the first set of data; writing, based at least in part on the command, the first set of data to a cache of the memory system in accordance with a first type of programming operation; and performing, after writing the first set of data to the cache of the memory system, a transfer operation to transfer a second set of data from the cache to a second portion of the memory system in accordance with a second type of programming operation, where the first set of data remains in the cache after the transfer operation based at least in part on the first set of data being associated with the tag.

Aspect 2: The method, apparatus, or non-transitory computer-readable medium of aspect 1, where performing the transfer operation includes operations, features, circuitry, logic, means, or instructions, or any combination thereof for refraining from transferring, as part of the transfer operation, the first set of data from the cache to the second portion of the memory system based at least in part on the first set of data being associated with the tag, where the tag indicates a high priority level.

Aspect 3: The method, apparatus, or non-transitory computer-readable medium of any of aspects 1 through 2, where performing the transfer operation includes operations, features, circuitry, logic, means, or instructions, or any combination thereof for determining, in response to a trigger associated with the transfer operation, whether the first set of data, the second set of data, or any combination thereof is associated with the tag and transferring the second set of data from the cache to the second portion of the memory system based at least in part on determining that the first set of data is associated with the tag.

Aspect 4: The method, apparatus, or non-transitory computer-readable medium of aspect 3, where the trigger is based at least in part on a quantity of data within the cache satisfying a threshold quantity, a command to perform the transfer operation, a latency condition, a garbage collection procedure, or any combination thereof.

Aspect 5: The method, apparatus, or non-transitory computer-readable medium of any of aspects 1 through 4, where the tag is based at least in part on the first set of data being associated with an artificial intelligence model, a machine learning model, or any combination thereof.

Aspect 6: The method, apparatus, or non-transitory computer-readable medium of any of aspects 1 through 5, where the tag is based at least in part on the first set of data being associated with a virtual random access space for a host system associated with the memory system.

Aspect 7: The method, apparatus, or non-transitory computer-readable medium of any of aspects 1 through 6, where the cache includes single-level memory cells and the second portion of the memory system includes multiple-level memory cells.

Aspect 8: The method, apparatus, or non-transitory computer-readable medium of any of aspects 1 through 7, further including operations, features, circuitry, logic, means, or instructions, or any combination thereof for receiving, at the memory system, a second write command to write a third set of data to the memory system, the third set of data not associated with the tag; writing, based at least in part on the second write command, the third set of data to the cache of the memory system in accordance with the first type of programming operation; and performing, after writing the third set of data to the cache of the memory system, a second transfer operation to transfer the third set of data from the cache to the second portion of the memory system in accordance with the second type of programming operation, where the first set of data remains in the cache after the second transfer operation based at least in part on the first set of data being associated with the tag.

Aspect 9: The method, apparatus, or non-transitory computer-readable medium of any of aspects 1 through 8, further including operations, features, circuitry, logic, means, or instructions, or any combination thereof for receiving, at the memory system, a second write command to write the second set of data to the memory system, where the second write command is received after the command to write the first set of data, and where the second set of data is not associated with the tag and writing, based at least in part on the second write command, the second set of data to the cache of the memory system in accordance with the first type of programming operation, where the first set of data is written to the cache prior to writing the second set of data to the cache, and where the second set of data is transferred to the second portion of the memory system as part of the transfer operation based at least in part on the second set of data not being associated with the tag.

Aspect 10: The method, apparatus, or non-transitory computer-readable medium of any of aspects 1 through 9, further including operations, features, circuitry, logic, means, or instructions, or any combination thereof for writing, to the cache, information that indicates the first set of data is associated with the tag.

Aspect 11: The method, apparatus, or non-transitory computer-readable medium of any of aspects 1 through 10, where the tag indicates a first priority of the first set of data.

Aspect 12: The method, apparatus, or non-transitory computer-readable medium of aspect 11, further including operations, features, circuitry, logic, means, or instructions, or any combination thereof for associating, based at least in part on the transfer operation, the first set of data with a second tag corresponding to a second priority different than the first priority and performing, after associating the first set of data with the second tag, a second transfer operation to transfer the first set of data from the cache to the second portion of the memory system in accordance with the second type of programming operation.

It should be noted that the described methods include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a command to write a first set of data to the memory system and an indication of a tag associated with the first set of data;
write, based at least in part on the command, the first set of data to a cache of the memory system in accordance with a first type of programming operation; and
perform, after writing the first set of data to the cache of the memory system, a transfer operation to transfer a second set of data from the cache to a second portion of the memory system in accordance with a second type of programming operation, wherein the processing circuitry is configured to cause the memory system to maintain the first set of data in the cache after the transfer operation based at least in part on the first set of data being associated with the tag.

2. The memory system of claim 1, wherein, to perform the transfer operation, the processing circuitry is configured to cause the memory system to:
refrain from transferring, as part of the transfer operation, the first set of data from the cache to the second portion of the memory system based at least in part on the first set of data being associated with the tag, wherein the tag indicates a high priority level.

3. The memory system of claim 1, wherein, to perform the transfer operation, the processing circuitry is configured to cause the memory system to:
determine, in response to a trigger associated with the transfer operation, whether the first set of data, the second set of data, or any combination thereof is associated with the tag; and
transfer the second set of data from the cache to the second portion of the memory system based at least in part on determining that the first set of data is associated with the tag.

4. The memory system of claim 3, wherein the trigger is based at least in part on a quantity of data within the cache satisfying a threshold quantity, a second command to perform the transfer operation, a latency condition, a garbage collection procedure, or any combination thereof.

5. The memory system of claim 1, wherein the tag is based at least in part on the first set of data being associated with an artificial intelligence model, a machine learning model, or any combination thereof.

6. The memory system of claim 1, wherein the tag is based at least in part on the first set of data being associated with a virtual random access space for a host system associated with the memory system.

7. The memory system of claim 1, wherein the cache comprises single-level memory cells, and wherein the second portion of the memory system comprises multiple-level memory cells.

8. The memory system of claim 1, wherein the processing circuitry is further configured to cause the memory system to:
receive, at the memory system, a second write command to write a third set of data to the memory system, the third set of data not associated with the tag;
write, based at least in part on the second write command, the third set of data to the cache of the memory system in accordance with the first type of programming operation; and
perform, after writing the third set of data to the cache of the memory system, a second transfer operation to transfer the third set of data from the cache to the second portion of the memory system in accordance with the second type of programming operation, wherein the processing circuitry is configured to cause the memory system to maintain the first set of data in the cache after the second transfer operation based at least in part on the first set of data being associated with the tag.

9. The memory system of claim 1, wherein the processing circuitry is further configured to cause the memory system to:
receive, at the memory system after the command to write the first set of data, a second write command to write the second set of data to the memory system, wherein the second set of data is not associated with the tag; and
write, based at least in part on the second write command, the second set of data to the cache of the memory system in accordance with the first type of programming operation, wherein the processing circuitry is configured to cause the memory system to transfer the second set of data to the second portion of the memory system as part of the transfer operation based at least in part on the second set of data not being associated with the tag.

10. The memory system of claim 1, wherein the processing circuitry is further configured to cause the memory system to:
write, to the cache, information that indicates the first set of data is associated with the tag.

11. The memory system of claim 1, wherein the tag indicates a first priority of the first set of data.

12. The memory system of claim 11, wherein the processing circuitry is further configured to cause the memory system to:
associate, based at least in part on the transfer operation, the first set of data with a second tag corresponding to a second priority different than the first priority; and
perform, after associating the first set of data with the second tag, a second transfer operation to transfer the first set of data from the cache to the second portion of the memory system in accordance with the second type of programming operation.

13. A method by a memory system, comprising:
receiving a command to write a first set of data to the memory system and an indication of a tag associated with the first set of data;
writing, based at least in part on the command, the first set of data to a cache of the memory system in accordance with a first type of programming operation; and
performing, after writing the first set of data to the cache of the memory system, a transfer operation to transfer a second set of data from the cache to a second portion of the memory system in accordance with a second type of programming operation, wherein the first set of data remains in the cache after the transfer operation based at least in part on the first set of data being associated with the tag.

14. The method of claim 13, wherein performing the transfer operation comprises:
refraining from transferring, as part of the transfer operation, the first set of data from the cache to the second portion of the memory system based at least in part on the first set of data being associated with the tag, wherein the tag indicates a high priority level.

15. The method of claim 13, wherein performing the transfer operation comprises:
determining, in response to a trigger associated with the transfer operation, whether the first set of data, the second set of data, or any combination thereof is associated with the tag; and
transferring the second set of data from the cache to the second portion of the memory system based at least in part on determining that the first set of data is associated with the tag.

16. The method of claim 15, wherein the trigger is based at least in part on a quantity of data within the cache satisfying a threshold quantity, a second command to perform the transfer operation, a latency condition, a garbage collection procedure, or any combination thereof.

17. The method of claim 13, wherein the tag is based at least in part on the first set of data being associated with an artificial intelligence model, a machine learning model, or any combination thereof.

18. The method of claim 13, wherein the tag is based at least in part on the first set of data being associated with a virtual random access space for a host system associated with the memory system.

19. The method of claim 13, wherein the cache comprises single-level memory cells, and wherein the second portion of the memory system comprises multiple-level memory cells.

20. The method of claim 13, further comprising:
receiving, at the memory system, a second write command to write a third set of data to the memory system, the third set of data not associated with the tag;
writing, based at least in part on the second write command, the third set of data to the cache of the memory system in accordance with the first type of programming operation; and
performing, after writing the third set of data to the cache of the memory system, a second transfer operation to transfer the third set of data from the cache to the second portion of the memory system in accordance with the second type of programming operation, wherein the first set of data remains in the cache after the second transfer operation based at least in part on the first set of data being associated with the tag.

21. The method of claim 13, further comprising:
receiving, at the memory system, a second write command to write the second set of data to the memory system, wherein the second write command is received after the command to write the first set of data, and wherein the second set of data is not associated with the tag; and
writing, based at least in part on the second write command, the second set of data to the cache of the memory system in accordance with the first type of programming operation, wherein the first set of data is written to the cache prior to writing the second set of data to the cache, and wherein the second set of data is transferred to the second portion of the memory system as part of the transfer operation based at least in part on the second set of data not being associated with the tag.

22. The method of claim 13, further comprising:
writing, to the cache, information that indicates the first set of data is associated with the tag.

23. The method of claim 13, wherein the tag indicates a first priority of the first set of data.

24. The method of claim 23, further comprising:
associating, based at least in part on the transfer operation, the first set of data with a second tag corresponding to a second priority different than the first priority; and
performing, after associating the first set of data with the second tag, a second transfer operation to transfer the first set of data from the cache to the second portion of the memory system in accordance with the second type of programming operation.

25. A non-transitory computer-readable medium storing code, the code comprising instructions executable by one or more processors to:
receive a command to write a first set of data to a memory system and an indication of a tag associated with the first set of data;
write, based at least in part on the command, the first set of data to a cache of the memory system in accordance with a first type of programming operation; and
perform, after writing the first set of data to the cache of the memory system, a transfer operation to transfer a second set of data from the cache to a second portion of the memory system in accordance with a second type of programming operation, wherein the first set of data remains in the cache after the transfer operation based at least in part on the first set of data being associated with the tag.
